(19) United States
(12) Patent Application Publication
(10) Pub. No.: US 2024/0196816 A1
(43) Pub. Date: Jun. 20, 2024

(54) Irrigation System

(71) Applicant: Andrey Abramyan, Panorama City, CA (US)

(72) Inventor: Andrey Abramyan, Panorama City, CA (US)

(21) Appl. No.: 18/133,518

(22) Filed: Apr. 11, 2023

Related U.S. Application Data
(60) Provisional application No. 63/330,059, filed on Apr. 12, 2022.

(51) Int. Cl. A01G 25/09; A01G 25/02; B64U 60/50; B64U 101/40; B64U 101/45

(52) U.S. Cl. CPC A01G 25/09; A01G 25/02; B64U 60/50; B64U 2101/40; B64U 2101/45

(57) ABSTRACT

An irrigation system for agriculture, wherein a water conduit comprising a plurality of sprinklers is supported by airborne lifting devices (such as drones or propellers) holding it up in the air at the right height for irrigation.

### CROSS-REFERENCE TO RELATED APPLICATIONS

The present application takes priority from Provisional App. No. 63/330,059, filed Apr. 12, 2022, which is incorporated herein by reference.

### BACKGROUND

### Field of the Invention

The system of the present invention pertains generally to large-scale agricultural irrigation systems, and more specifically to agricultural irrigation systems that do not require contact with the ground.

### Background of the Invention

Irrigation of large fields is very important in agriculture. Usually, this is accomplished by either a center-pivot system or a linear-move system, where a long pipe comprising several sprinklers along its length is moved either in a circle around a center point (as with a center-pivot system) or perpendicular to its length along a field (as with a linear-move system). In a center-pivot system, the water is supplied at the center point; in a linear-move system, the water is pumped from a ditch alongside the field. In either case, the length of the pipe is supported by wheeled supports so that the pipe remains at a constant distance from the ground. The irrigation may be performed using solely water, chemical fertilizers or herbicides, or both.

One problem with the prior-art systems is that the wheeled supports take up space on the ground as they roll along it, meaning that crops cannot be planted in their path. Depending on the size of the field and the number of wheeled supports needed, this can represent a significant loss of planting area.

An additional problem with prior art systems is that they cannot handle uneven ground and that their height cannot be adjusted. Furthermore, circular-pivot prior art systems typically can't accommodate non-circular fields or overlap.

A need exists for an irrigation system that does not require wheeled supports, can adjust the height of the irrigation, and allows for non-circular or overlapping fields.

### SUMMARY OF THE INVENTION

An object of the present invention is to provide an irrigation system that does not require any loss of planting area.

Another object of the present invention is to provide an irrigation system that does not touch the ground anywhere except at the water intake point.

Another object of the present invention is to provide an irrigation system that is supported by airborne lifting devices, such as propellers or drones.

In an aspect of the present invention, an irrigation system is provided, comprising a water conduit with a plurality of sprinklers located along its length, connected to a water source at one end. At least two airborne lifting devices, such as drones or propellers, are attached to the water conduit to lift it into the air. A controller is connected to the airborne lifting devices and sprinklers, configured to control the airborne lifting devices and sprinklers in such a way as to move the water conduit over an area of land and irrigate it.

The irrigation system may also comprise at least one landing gear, which comprises at least two feet protruding below the water conduit, so that the water conduit is supported when the airborne lifting devices are not operating. The landing gear may be attached to the airborne lifting devices.

In an aspect of the present invention, the system of the present invention may comprise at least one stiffener attached to the water conduit. The stiffener may be located along the entire length of the water conduit or may be located between two adjacent airborne lifting devices. In an aspect of the present invention, the stiffener may comprise an arch frame and a plurality of support beams that connect the arch frame and the water conduit.

In an aspect of the present invention, the system may comprise a communication module to communicate with a mobile device. The mobile device may then receive or send information to the controller.

In an aspect of the present invention, the controller can control the height of the water conduit. In an aspect of the present invention, the controller can also turn individual sprinklers on and off in order to control the shape of the irrigated area.

In an aspect of the present invention, a supplementary reservoir may be provided, containing a substance that may be mixed with the irrigation water.

In an aspect of the present invention, an end-gun may be located at the end of the water conduit.

In an aspect of the present invention, the irrigation system is a center-pivot system and each sprinkler has a flow rate that is dependent on its distance from the water source.

### LIST OF FIGURES

FIG. 1 shows a diagram of an embodiment of the system of the present invention.

FIG. 2 shows a diagram of an alternate embodiment of the system of the present invention.

FIG. 3 shows a large-scale diagram of the fields irrigated by the system of the present invention.

FIG. 4A shows a large-scale diagram of a field irrigated by the system of the present invention.

FIG. 4B shows a large-scale diagram of a field irrigated by the system of the present invention.

FIG. 5 shows a diagram of the communication between the elements of the system of the present invention.

FIG. 6 shows a sample screenshot from a mobile device involved in an embodiment of the system of the present invention.

FIG. 7 shows a sample screenshot from a mobile device involved in an embodiment of the system of the present invention.

FIG. 8 shows an embodiment of a VR component of the system of the present invention.

FIG. 9 shows a diagram of the monitoring and resource allocation of the system of the present invention.

### DETAILED DESCRIPTION OF THE PREFERRED EMBODIMENT

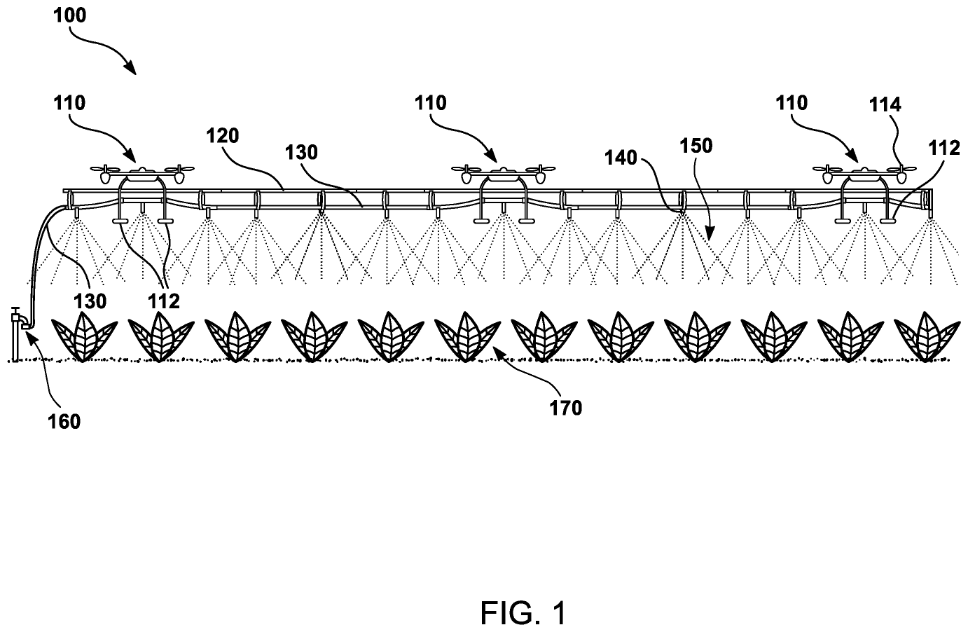

FIG. 1 shows a diagram of an embodiment of the irrigation system 100 of the present invention in a center-pivot system, used to water crops 170. Water comes out of the water outlet 160 and goes through water conduit 130, going out through sprinklers 140 as spray 150. The water conduit 130 is supported in the air by airborne lifting devices 110. The airborne lifting devices are powered by wired electric power 120 (but may also be battery-powered or solar-powered). The system 100 then rotates around the water outlet 160 in order to water the crops 170 in a circular pattern. The system 100 is controlled by a controller (not shown) which sends control signals to the airborne lifting devices and the sprinklers.

The system of the present invention may be either a center-pivot system or a linear system, as long as the water source is such as to allow for movement. While a center-pivot system is described in this disclosure, it is not meant to be limiting in this respect. In the center-pivot embodiment of the present invention, an end-gun may be included to cover the corners of the field to be irrigated.

Airborne lifting devices 110 may be drones, propellers, or any other airborne lifting device that is sufficient to support the weight of the water conduit in question and provide horizontal movement. In the preferred embodiment, quad-propeller drones (comprising four rotors 114) are used to provide stability and maneuverability, but other propeller arrangements are also possible for the present invention, as long as the airborne lifting device can support the weight of the water conduit and move it in a lateral direction. The number of airborne lifting devices may be any number as long as they do not interfere with each other and as long as they provide enough lift to support the weight of the water conduit. As mentioned, the airborne lifting devices may be battery-powered, solar-powered, or powered by a cable attached to the water conduit.

Sprinklers 140 may be any types of sprinklers or nozzles that can be used with crop irrigation. In an embodiment, each sprinkler 140 may have an adjustable or different flow rate; in another embodiment, all the sprinklers have the same flow rate. In an embodiment, the sprinklers are independently controllable by the controller to turn on and off or to adjust their flow rate, as will be discussed below. In an alternate embodiment, the sprinkler flow rate for each sprinkler is adjusted so that the sprinklers close to the perimeter of the circular area to be watered have a higher flow rate and the sprinklers close to the center have a lower flow rate. The flow rate is preferably adjusted so that the entire irrigated area is watered evenly at the same rate.

The advantage of this system is that it does not require any contact with the ground, meaning that no planting area is lost. Another advantage is that it can be deployed at any height, depending on the needs of the crop being watered, and the height can be dynamically adjusted easily to account for crop height, avoid obstacles, or provide more or less focused irrigation. Another advantage is that the present system does not depend on the ground being flat or free of obstacles: it can operate no matter what the ground conditions are.

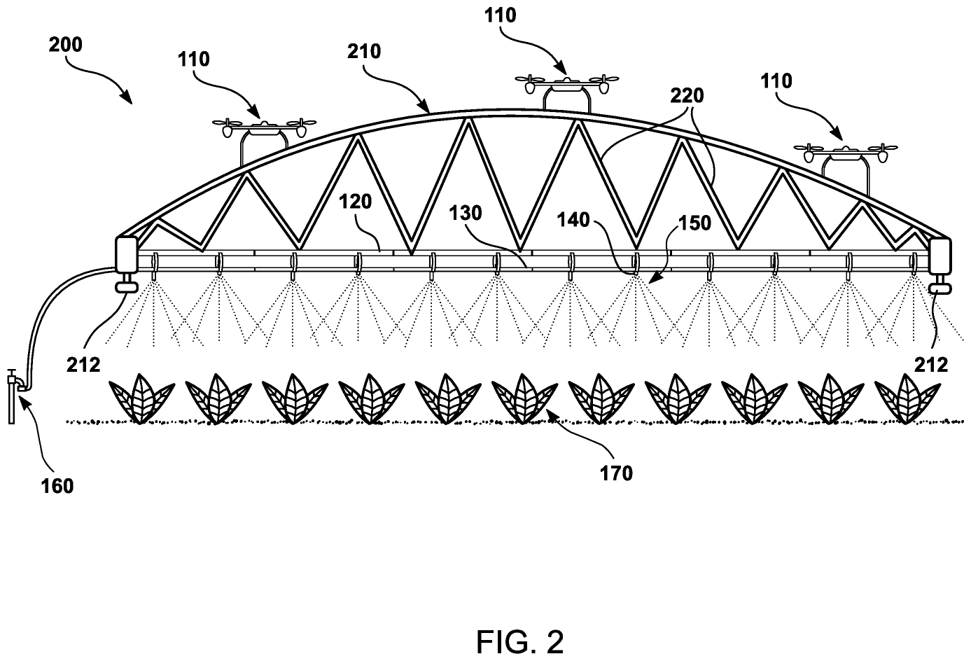

FIG. 2 shows an alternate embodiment of the present invention comprising a stiffener 200. The stiffener 200 is used to provide rigidity to the water conduit to prevent flexing and to enable the water conduit to move as a unit. In this embodiment of the present invention, the stiffener comprises an arch frame 210 and support beams 220 to provide vertical rigidity. In another embodiment, another stiffener may be attached horizontally to provide horizontal rigidity. As shown in the Figure, the airborne lifting devices 110 may be attached to the stiffener rather than to the water conduit. The stiffener is preferably made of aluminum or plastic or any other lightweight and rigid material.

In alternate embodiments, a stiffener may be provided only between individual airborne lifting devices to maintain the proper distance between them, rather than extending the entire length of the water conduit. In an embodiment, every stretch of water conduit between two airborne lifting devices is reinforced with a stiffener. The stiffeners could be tube-shaped to fit around the water conduit or could be any other shape that would prevent flexing of the water conduit.

In another embodiment, no stiffeners are used at all.

While the water source is shown as a water outlet 160, it may also comprise a supplementary reservoir containing fertilizers, pesticides, herbicides, or any other substances that could be mixed with the water. In an embodiment of the present invention, a pump is connected to the supplementary reservoir and a pipe connects it to the water outlet 160. The substance contained in the supplementary reservoir is then pumped into the water before it is used to irrigate the area of land.

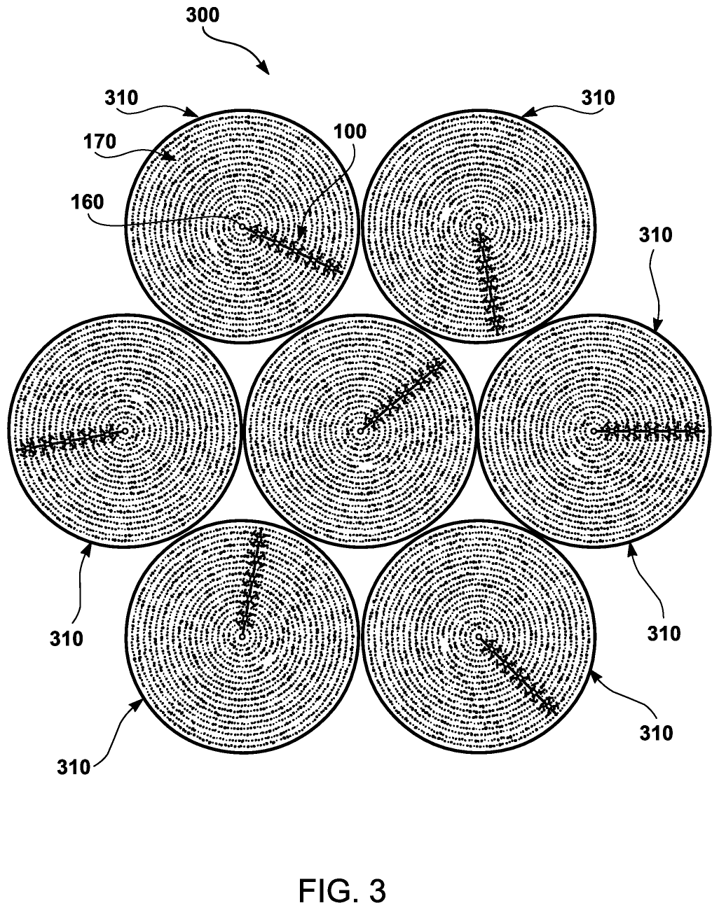

FIG. 3 shows a diagram of multiple circular fields 310 irrigated by systems of the present invention. In an embodiment, end-guns may be used to fill the gaps between the circular fields 310 and allow for more planting area.

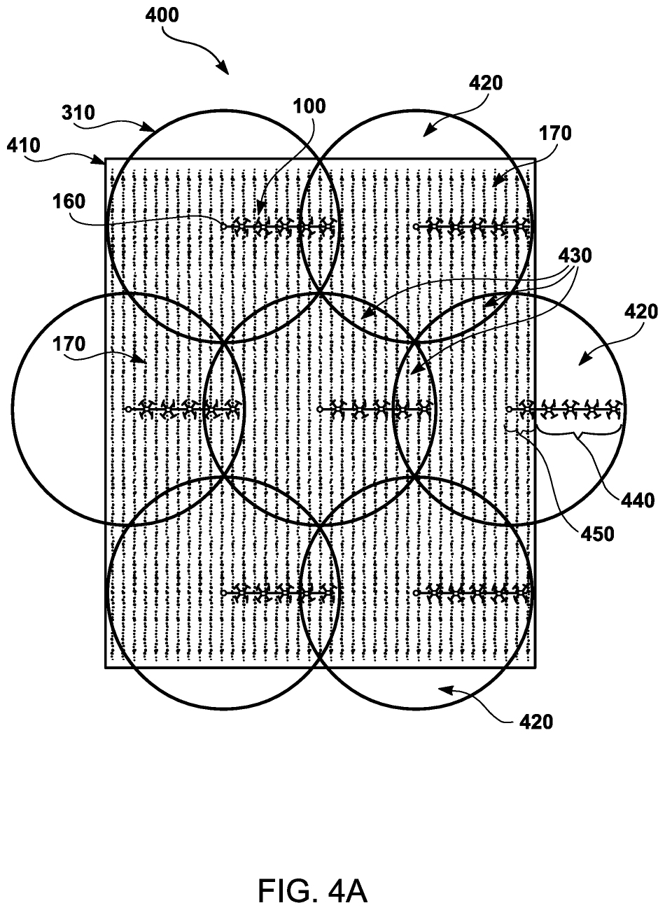

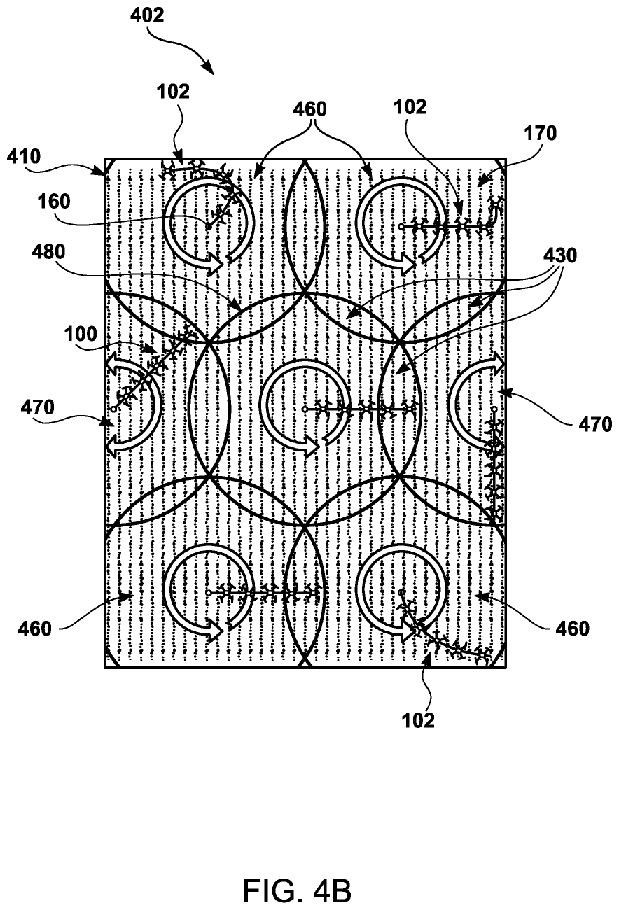

FIG. 4A shows a diagram of a rectangular field evenly watered by systems of the present invention. The field is defined by its perimeter 410. Multiple overlapping center-pivot systems 100 are located within the field. Since each sprinkler is controlled individually, the system may turn each one on and off as needed. Thus, any sprinkler entering the non-irrigated zone 420 is turned off, since no watering is desired in that zone. For any overlapping zones 430, any sprinkler entering that zone may be throttled back to approximately half its output, so that the crops in the overlapping zones are watered at the same rate as the crops in the other zones. Finally, the irrigation systems 100 communicate with each other and coordinate so that they do not collide in the overlapping regions. All of these functions are handled by a controller, which is preferably connected to a computing device or a mobile device in order to enable it to perform these functions. In an alternate embodiment, the controller itself is a computing device that comprises a processor and memory sufficient to perform these functions.

In an alternate embodiment, shown in FIG. 4B, the water conduit is flexible due to the stiffeners only being placed between individual airborne lifting devices or no stiffeners being used at all. As shown, the water conduits close to the edges of the field can flex in order to avoid irrigating the areas outside the field. In this embodiment, some of the water conduits make a full circle 480: some of the water conduits flex as they pass by a fence or other obstacle 460; and some make only a partial arc 470.

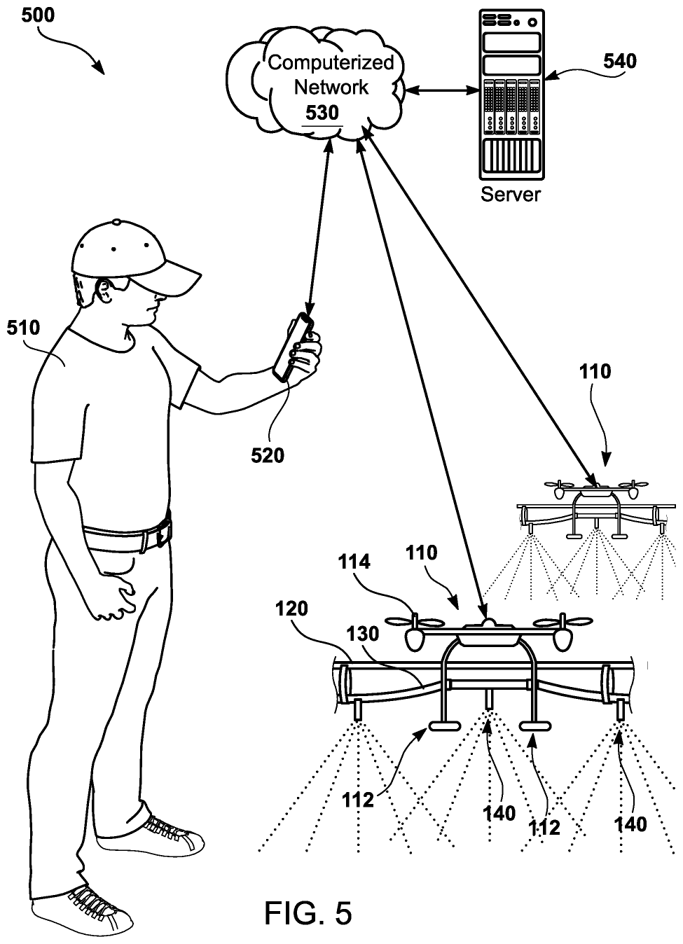

FIG. 5 shows an embodiment 500 of the system of the present invention in the aspect of connecting to a mobile device. Farm worker 510 may use a mobile device 520 to connect to the server 540 via a computerized network 530; the server 540 then sends control signals to the airborne lifting devices 110 and sprinklers 140 and receives data from them regarding their status or operation. The connection is preferably wireless, either through Wi-Fi, cellular data, or another wireless communication protocol that could work at the distances required for this application.

In an embodiment, each drone or airborne lifting device may comprise a sub-controller that controls the sprinklers in close proximity to that drone or airborne lifting device. This provides a simpler method of controlling the sprinklers that does not rely on long-range wireless transmission. The controller then controls the sub-controllers and each sub-controller controls the sprinklers. The sub-controller may comprise a processor and memory that is sufficient to control a plurality of sprinklers and a communication device that communicates with the controller. In an embodiment, the sub-controller connects to each sprinkler by wired connection and connects to the controller wirelessly.

FIG. 5 also shows the details of the drone embodiment of the airborne lifting device 110 of the present invention, showing the rotors 160. In one aspect of the present invention, landing gear 112 is included in the present invention. The landing gear 112 preferably comprises at least two feet as shown that protrude in a downward direction below the water conduit and the sprinklers 140; in alternate embodiments, other shapes of landing gear are possible as long as it protrudes below the water conduit and the sprinklers are provides stable support to the system when it is resting on the ground. This prevents dirt from clogging the sprinklers if the system is not operating.

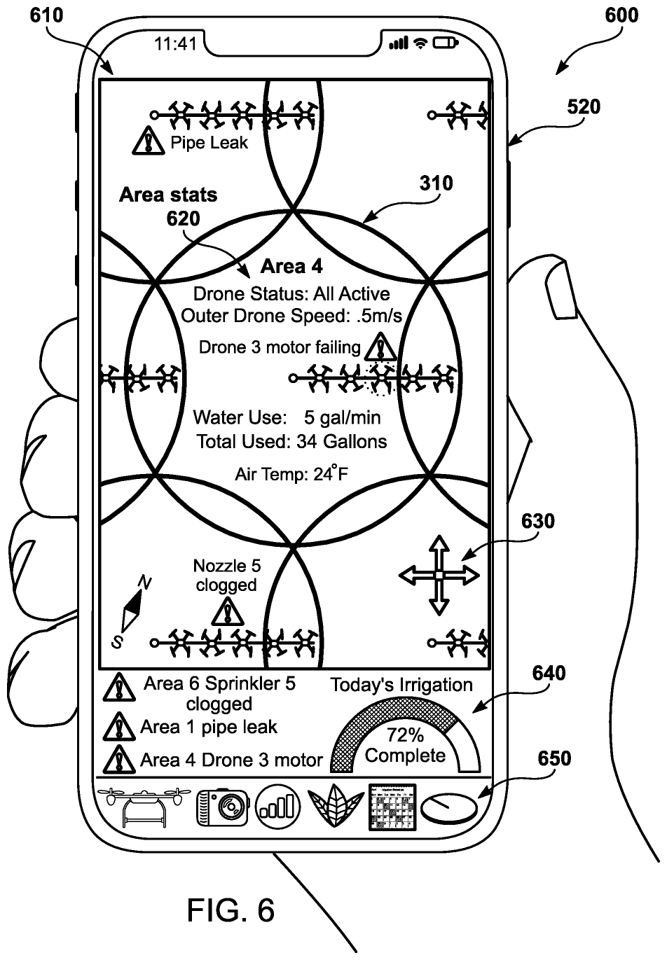

FIG. 6 shows a screenshot of a mobile device 520 showing the operation of the software system of the present invention. As can be seen in the screenshot, an app 610 is provided to display the status of the irrigation system: the app provides a user interface 650 to allow the user to select different screens and different functions. In an embodiment, the area stats 620 are displayed on the screen (for example, the drone status, outer drone speed, water use, total water used, air temperature, and so on). The app can also display various alerts to alert the user to various problems (pipe leaks, clogged sprinklers, drone motors failing, etc.) and the percentage of the irrigation completed 640. The app may also offer a way to navigate the map 630.

In an embodiment, the drones 110 comprise cameras and the app may also display a drone camera feed. This enables the farm worker to see the crop status and health in real time.

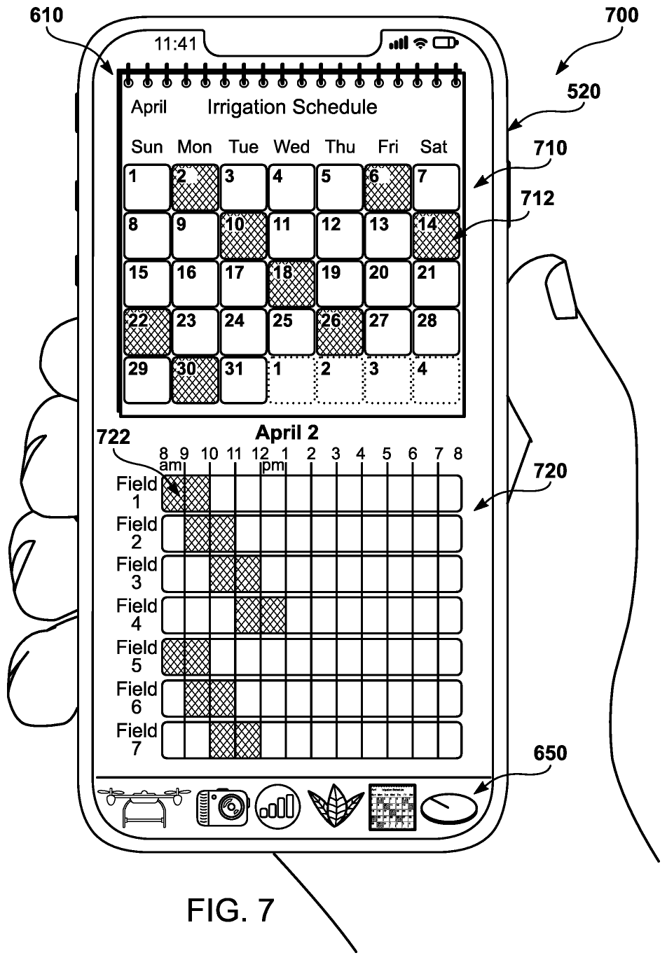

FIG. 7 shows a screenshot of the mobile device 520 providing a scheduling system for the software system of the present invention. The scheduling may be done on the calendar 710 to schedule irrigation days, and on a time screen 720 to schedule irrigation times for each field individually. It is to be understood that any other scheduling structure is also consistent with the present invention.

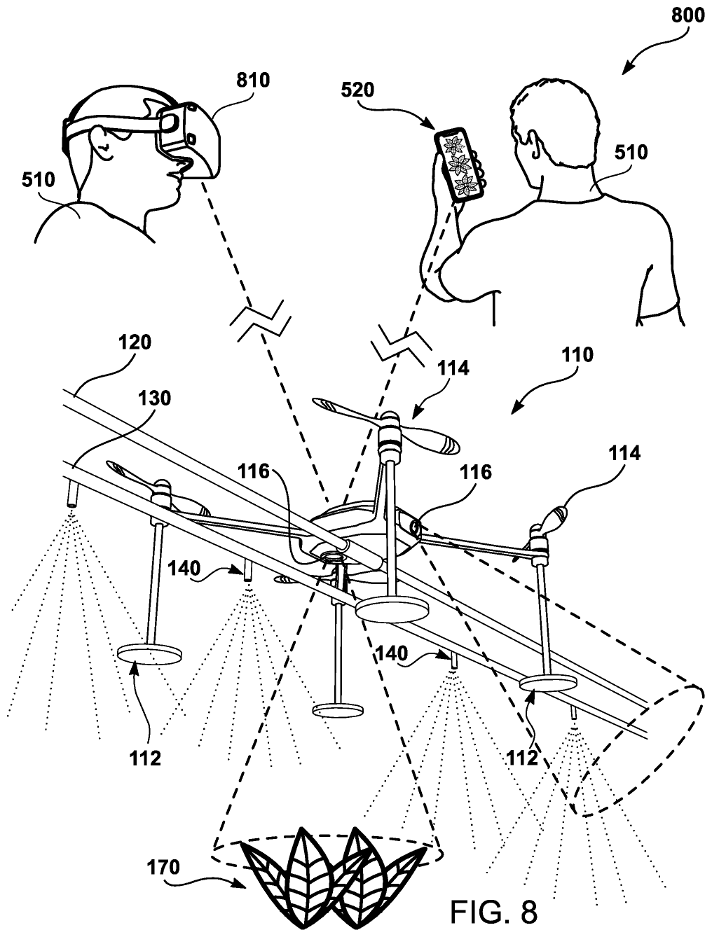

FIG. 8 shows an embodiment of the present invention where each drone 110 comprises a camera. A farm worker 510 may then be able to see the status of the crops 170 on a mobile device 520 or via virtual reality glasses 810. Any other mobile or stationary device may also be used to display the camera feed from the drone 110.

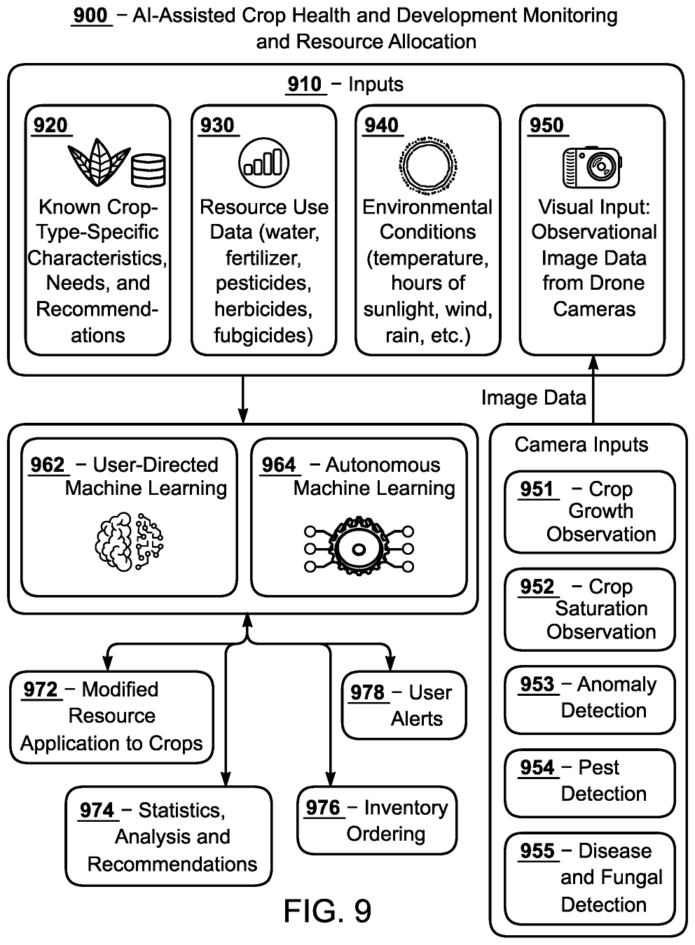

In an embodiment, shown in FIG. 9, an AI system may be used to monitor crop health and development and to allocate resources. Inputs 910 are fed into the system. For example, the inputs may be crop-type specific characteristics, needs, and recommendations 920, resource use data 930, environmental conditions 940, and visual input 950 (observational image data from the drone cameras). The image data in question may be crop growth observation 951, crop saturation observation 952, anomaly detection 953, pest detection 954, and disease/fungal detection 955. The inputs are then fed into either user-directed machine learning 962 or autonomous machine learning 964, to produce outputs such as user alerts 978, inventory ordering 976, modified resource application to crops 972, and statistics, analysis, and recommendations 974. The outputs and inputs are then used to train the machine learning system further.

It is understood that the embodiments described in the present disclosure are solely illustrative, and that equivalents may be employed and substitutions may be made without departing from the scope of the technology as recited in any claims stemming from this application.

1. An irrigation system, comprising:
a water conduit comprising a plurality of sprinklers located along its length, wherein the water conduit is connected to a water source at one end of the water conduit:
at least two airborne lifting devices to lift the water conduit into the air;
a controller connected to the at least two airborne lifting devices and the plurality of sprinklers, wherein the controller is configured to control the sprinklers and the airborne lifting devices:
wherein the controller is configured to use the airborne lifting devices and the sprinklers to move the water conduit in such a way as to irrigate an area of land.

2. The irrigation system of claim 1, wherein the airborne lifting devices are propellers.

3. The irrigation system of claim 1, wherein the airborne lifting devices are drones.

4. The irrigation system of claim 1, further comprising at least one landing gear, wherein the landing gear comprises at least two feet protruding below the water conduit, wherein the at least two feet support the water conduit when at least one airborne lifting device is not operating.

5. The irrigation system of claim 1, wherein the at least one landing gear is attached to the at least one airborne lifting device.

6. The irrigation system of claim 1, comprising at least one stiffener.

7. The irrigation system of claim 6, wherein the at least one stiffener is located between two adjacent airborne lifting devices.

8. The irrigation system of claim 6, wherein the at least one stiffener is located along an entire length of the water conduit.

9. The irrigation system of claim 8, wherein the at least one stiffener comprises:
an arch frame:
support beams connecting a plurality of points on the arch frame and a plurality of points on the water conduit.

10. The irrigation system of claim 1, wherein the controller comprises a communication module, wherein the communication module communicates wirelessly with a mobile device.

11. The irrigation system of claim 10, wherein the mobile device is configured to display information related to the irrigation system and to send control signals to the controller.

12. The irrigation system of claim 1, wherein the controller is further configured to control the height of the water conduit.

13. The irrigation system of claim 1, wherein the controller is configured to turn at least one sprinkler on and off in order to avoid irrigating an area where irrigation is not desired.

14. The irrigation system of claim 1, further comprising:
a supplementary reservoir connected to the water source, wherein the supplementary reservoir contains a substance;
a pump connected to the supplementary reservoir for pumping the substance into the water for irrigation.

15. The irrigation system of claim 1, further comprising an end-gun located at an end of the water conduit.

16. The irrigation system of claim 1, wherein the irrigation system is a center-pivot system, wherein each sprinkler has a flow rate that is dependent on its distance from the water source, wherein each flow rate is calibrated so that each part of the area of land is watered at the same rate.

17. The irrigation system of claim 1, wherein each airborne lifting device comprises a sub-controller, wherein each sub-controller controls at least one sprinkler in close proximity to the airborne lifting device, and wherein the controller controls all the sub-controllers.
